(19) United States
(12) Patent Application Publication
(10) Pub. No.: US 2012/0164055 A1
(43) Pub. Date: Jun. 28, 2012

(54) METHOD OF REMOVAL OF IMPURITIES FROM SILICON

(75) Inventors: Mansoor Barati Sedeh, North York (CA); Torstein Utigard, Mississauga (CA)

(73) Assignee: THE GOVERNING COUNCIL OF THE UNIVERSITY OF TORONTO, Toronto, ON (CA)

(21) Appl. No.: 13/380,677

(22) PCT Filed: Jun. 22, 2010
(86) PCT No.: PCT/CA2010/000928

§ 371 Date: Mar. 15, 2012

Related U.S. Application Data
(60) Provisional application No. 61/219,879, filed on Jun. 24, 2009.

(51) Int. Cl. C01B 33/037

(52) U.S. Cl. 423/348

(57) ABSTRACT

A method for the purification of metallurgical grade silicon is provided, which can be used to produce high purity silicon up to and including solar grade. The process relies on alloying and controlled solidification of Si with another metal, such as copper, zinc, iron, tin, nickel and aluminum, to produce purified platelets of Si, while the impurities are trapped in a getter alloy. The Si platelets are then separated from the solidified alloy by a physical separation technique such as gravity or magnetic separation. The separated grains of Si may then be further cleaned by acid leaching. Pre-refining of metallurgical grade silicon or post-refining of the product may be performed, depending on the initial impurity content of the feedstock, to obtain Si that meets solar grade requirements.

### CROSS-REFERENCE TO RELATED APPLICATION

This application claims priority to U.S. Provisional Application No. 61/219,879, titled “METHOD OF REMOVAL OF IMPURITIES FROM SILICON” and filed on Jun. 24, 2009, the entire contents of which are incorporated herein by reference.

### FIELD OF THE INVENTION

The present invention relates to the purification of silicon. More particularly, the present invention relates to the purification of metallurgical grade silicon by forming a silicon alloy, solidifying the alloy, and separating silicon from the alloy.

### BACKGROUND OF THE INVENTION

Increased awareness on climate change and the scarcity of traditional energy resources have put an immense thrust towards exploiting renewable and green energies. Beside other renewable energy sources, photovoltaics (PV) presents a source of clean and inexhaustible energy. In the last two decades, the PV industry has seen a vast increase in production of solar energy and the demand for solar panels. For example, solar cell energy production rose 67% from 2003 to 2004 [1].

The base material for manufacturing of solar cells is silicon. With the boost of the PV industry, the demand for silicon has increased significantly over the last decade. It is estimated that the demand for solar grade silicon (SOG-SI) will continue to rise between 20 to 30% per year [2]-[4]. To date, the major feedstock for production of solar cells has been scrap and rejects from the electronic industry, known as electronic grade silicon (EG-SI). However, a dedicated process of manufacturing SOG-Si at low cost is highly needed [5].

A process of purification of metallurgical grade silicon is disclosed by J. L. Gumaste et al. [6] using aluminum as the solvent/trapper of impurities. The silicon platelets (dendrites) were scraped off the wall of the crucible after residual alloy (liquid) was drained. The recovered Si was then further purified by acid leaching.

P. S. Kovtal et al. [7] discloses a process in which metallurgical grade silicon (MG-Si) is alloyed with aluminum and is solidified to grow pure silicon dendrites from the liquid. The alloy is put in contact with a silicate slag during melting, to enhance removal of some impurities. Also, the alloy is somewhat directionally solidified by removing the crucible gradually from the furnace hot zone. The Si platelets are separated from the eutectic alloy by allowing molten alloy to flow through a centrifugal filter. The adherent aluminum is then removed by washing the material with alcohol.

T. Yoshikawa et al. [8-11] describe how the segregation ratios of impurities between solid silicon and the Si—Al melt have been determined experimentally and theoretically to discuss the purification of MG-Si. The experiments are based on temperature gradient zone melting (TGZM) and the focus is mainly on P and B removal. The distribution of phosphorus and boron between solid and the liquid Si—Al alloy at 1173-1373 K has been investigated, where molten Si—Al is equilibrated with single crystalline pure silicon. The segregation ratios of B and P between solid silicon and the Si—Al melt were obtained and compared with the segregation coefficients of the same elements between solid/liquid silicon at its melting temperature. It was concluded that this method of purification is more effective than zone refining or directional solidification for removal of P and B.

J. Park et al. [12] disclose a method that is based on the separation of solid Si from the Si—Al alloy using electromagnetic force. The separation of Si in the hyper-eutectic Al—Si alloy was achieved by applying Pinch force from the difference in the conductivities of Al—Si melt and solid Si under the DC electric field with a steady magnetic field.

T. Yoshikawa et al. [13] provide a method of refining Si by the solidification of a Si—Al melt using gravity forces. In order to investigate the behavior of solidified Si grains from a Si—Al melt by flotation, Si-55.3 at % Al alloys were held at 1173 K. It was found that the Si grains and particles distributed uniformly in the sample without floatation during the experiment. Therefore, it was concluded that the separation of the solidified Si from the Si—Al melt by floatation is difficult probably due to the high viscosity of the melt in which particles dispersed. It was thus concluded that the use of gravity force was not effective as a separation method. Also described in this work is a method for separating Si grains solidified from a Si—Al melt by the use of electromagnetic force under a fixed AC magnetic field. It was found that solidification of Si—Al alloy under a magnetic field can bring extensive segregation of Si by induced temperature gradient and fluid flow surpassing the gravity force.

T. Yoshikawa et al. [14] described also a method involving the continuous solidification of Si from a Si—Al melt under induction heating. The concept of this process is based on dissolution-solidification using Si—Al alloy, melted by induction heating. The laboratory experiments have been carried out as follows; Si was supplied to the Si—Al solvent by dissolving a Si rod placed at the upper side of solvent, and also simultaneously solidified below the solvent utilizing the controlled temperature gradient induced under a fixed AC magnetic field. This technique followed by leaching allowed the effective collection of solidified silicon from the alloy.

J. S. Kang et al. [15] and M. L. Polignano et al. [16] describe a method that involves absorbing impurities from crystalline silicon by phosphorus diffusion. In these series of experiments it has been shown that low-temperature phosphorus diffusion can be used to remove other impurities such as Cu, Ni, and Fe. However, this process inevitably results in increasing the P concentration of Si. No mention has been made regarding removing this excess phosphorous after diffusion.

All the methods for separating purified silicon from the remaining alloy described above are expensive, complex or often yield poor results. What is therefore required is a method of purification and separation of silicon that is simple, inexpensive, and effective.

### SUMMARY OF THE INVENTION

In a first aspect, there is provided a method for reducing a concentration of an impurity in impure silicon, comprising the steps of: forming a liquid alloy comprising the impure silicon and a getter metal; cooling the liquid alloy to obtain silicon platelets within the liquid alloy; solidifying the liquid alloy to form a solid comprising the silicon platelets and a silicon-getter alloy; processing the solid to obtain particles of sufficiently small size that a fraction of the particles are substantially silicon particles formed from the platelets; and separating the substantially silicon particles; wherein a solubility of the impurity is greater in the getter metal than in the silicon platelets.

The impure silicon is preferably metallurgical grade silicon, and the impure silicon preferably has a silicon concentration of greater than approximately 96%.

The getter metal may comprise a metal or an alloy, and may be selected from the group consisting of copper, nickel, tin, iron, zinc. The alloy may comprise the metal and aluminum. A solubility of the getter metal in silicon is preferably less than approximately 1 ppmwt. A phase diagram of silicon and the getter metal preferably comprises a concentration range of the getter metal wherein the silicon platelets may form within the liquid alloy, and wherein a concentration of the getter metal is chosen to lie within the concentration range. The getter metal preferably has a purity of greater than about 99%.

A quantity of titanium may be added to the liquid alloy to reduce a concentration of boron in the substantially silicon particles. The method may further comprise the step of adding a quantity of calcium to the liquid alloy to reduce a concentration of phosphorus in the substantially silicon particles.

The cooling is preferably performed at a rate of approximately 0.03 to 3° C. per minute.

The step of processing the solid may be selected from the group consisting of crushing, milling, ball-milling and grinding. Particles obtained after the processing step are preferably filtered by particle size to obtain particles with an average size in the range of approximately 40-1200 microns.

The particles may be separated by gravity separation wherein a specific gravity of the getter metal is substantially different from the specific gravity of silicon. This may be achieved by adding particles obtained after the processing step to a liquid having a specific gravity between that of the getter metal and that of silicon. It is preferred that prior to the step of separating the particles, a substantially uniform particle size distribution is obtained, and lighter particles are subsequently separated from heavier particles by feeding the particles with a substantially uniform size distribution to an upward flowing stream, a cyclone, or a mechanical classifier.

Alternatively, the particles may be separated by magnetic separation wherein the magnetic susceptibility of the getter metal is substantially different from the magnetic susceptibility of silicon, and where more preferably, the getter metal is ferromagnetic. Low or high intensity magnetic separators may be used to perform the separation.

Particles obtained after the separation step may be chemically leached to further improve a purity of the substantially silicon particles.

In another aspect, there is provided a method for reducing a concentration of an impurity in impure silicon, comprising the steps of: forming a liquid alloy comprising the impure silicon and a getter metal, cooling the liquid alloy to obtain silicon platelets within the liquid alloy; solidifying the liquid alloy to form a solid comprising the silicon platelets and a silicon-getter alloy; and separating the silicon platelets from the silicon-getter alloy by chemical leaching, wherein a solubility of the impurity is greater in the getter metal than in silicon, and a solubility of the getter metal in silicon is selected to limit the formation of impurities in the platelets by the getter metal. The chemical leaching may be achieved with a leachant selected from the group consisting of HNO3, HCl, and HF.

The getter metal preferably a metal or an alloy, and a solubility of the getter metal in silicon is preferably less than approximately 1 ppmwt. A phase diagram of silicon and the getter metal preferably comprises a concentration range of the getter metal wherein the silicon platelets may form within the liquid alloy, and wherein a concentration of the getter metal is chosen to lie within the concentration range.

The impure silicon is metallurgical grade silicon, and the getter metal is preferably selected from the group consisting of copper, nickel, tin, iron, zinc. The getter metal may further comprise an alloy comprising the metal and aluminum.

A further understanding of the functional and advantageous aspects of the invention can be realized by reference to the following detailed description and drawings.

### BRIEF DESCRIPTION OF THE DRAWINGS

The embodiments of the present invention are described with reference to the attached figures, wherein:

FIG. 1 provides a flow chart illustrating a method of purifying silicon.

FIG. 2 shows a phase diagram for Si and candidate getter metals according to the method.

FIG. 3 shows an image revealing the microstructure of Si—Cu alloy after solidification

### DETAILED DESCRIPTION OF THE INVENTION

Generally speaking, the systems described herein are directed to a method of purifying silicon by alloy solidification and subsequent separation. As required, embodiments of the present invention are disclosed herein.

However, the disclosed embodiments are merely exemplary, and it should be understood that the invention may be embodied in many various and alternative forms. The Figures are not to scale and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present invention. For purposes of teaching and not limitation, the illustrated embodiments are directed to a method of purifying silicon by alloy solidification and subsequent separation.

As used herein, the terms, “comprises” and “comprising” are to be construed as being inclusive and open ended, and not exclusive. Specifically, when used in this specification including claims, the terms, “comprises” and “comprising” and variations thereof mean the specified features, steps or components are included. These terms are not to be interpreted to exclude the presence of other features, steps or components.

As used herein, the terms “about” and “approximately, when used in conjunction with ranges of dimensions of particles, compositions of mixtures or other physical properties or characteristics, is meant to cover slight variations that may exist in the upper and lower limits of the ranges of dimensions so as to not exclude embodiments where on average most of the dimensions are satisfied but where statistically dimensions may exist outside this region. It is not the intention to exclude embodiments such as these from the present invention.

As used herein, the coordinating conjunction “and/or” is meant to be a selection between a logical disjunction and a logical conjunction of the adjacent words, phrases, or clauses. Specifically, the phrase “X and/or Y” is meant to be interpreted as “one or both of X and Y” wherein X and Y are any word, phrase, or clause.

As used herein, the term “platelet” refers to solid silicon formed within a liquid alloy, and comprises dendrites, needles, and/or grains.

Embodiments disclosed herein provide metallurgical and phase separation techniques for the purification of silicon that are technically feasible and energetically favored compared to the other known processes. Briefly, a preferred embodiment provides a method wherein the impurities in a silicon metal are trapped in another phase by controlled alloying, solidification, and separation. Silicon containing impurities is melted with one or more getter metal(s), and a liquid alloy is formed. During cooling of the alloy, silicon platelets with increased purity grow from the liquid while the impurities remain in the liquid. The silicon platelets are then separated from the alloy by a comminution and subsequent separation step. Preferred separation methods include gravity and magnetic separation, as further described below.

The separated silicon may be further purified, for example, to obtain photovoltaic grade silicon, using other known refining methods. Pre-refining of metallurgical grade silicon or post-refining of the purified product may be performed, depending on the initial impurity content of the feedstock, to obtain silicon that meets the preferred purity requirements.

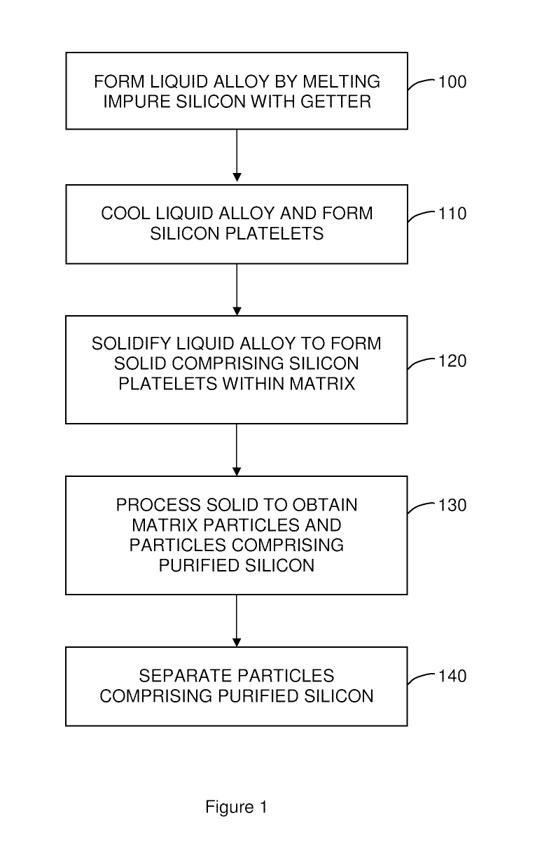

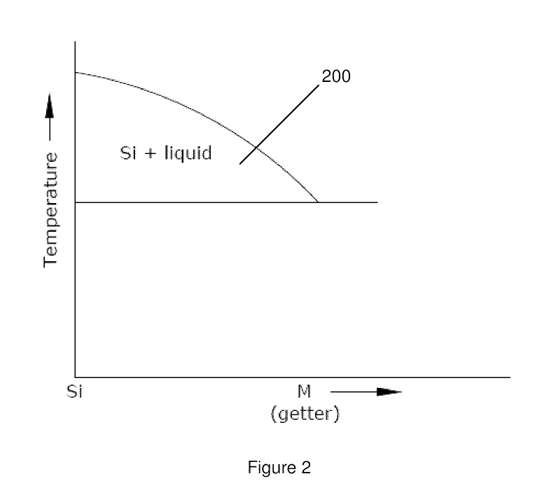

Referring to FIG. 1, a flow chart is provided describing the method of purification. In step 100, silicon containing impurities is melted with one or more getter metal(s) to obtain a liquid alloy. The silicon and getter metal(s) exhibit a phase diagram that allows formation of Si platelets from the alloy during the solidification. For a binary Si-getter system, such phase diagram is shown in FIG. 2. The concentration of the getter metal is chosen so that a phase exists whereby silicon platelets form within the liquid alloy during cooling. The getter metal is selected to absorb and retain the impurities of silicon, whereby the solubility of at least some of the impurities is higher in the liquid alloy than in the growing silicon platelets. Furthermore, the solubility of the getter metal in silicon should be low, so that it will not dissolve into silicon and act as an impurity itself. In other words, the segregation coefficient of the getter metal in silicon should be low enough so that the concentration of the getter metal in purified silicon product meets the desired purification requirements. Additionally, the getter metal is preferably a low cost metal or alloy and is also preferably readily recyclable. Based on this criteria, iron, copper, zinc, and nickel, tin, as well as alloys of these metals with aluminum, are preferable compositions for the getter metal.

In step 110, the liquid is cooled and silicon platelets are formed within the liquid. This is achieved by selecting the concentration of the getter metal so that the phase diagram of the alloy (FIG. 2) includes a region where pure solid silicon and liquid silicon-getter alloy are in equilibrium. By cooling the liquid at a cooling rate that is sufficiently slow for the diffusion of impurities, the impurities are preferentially accumulated in the getter metal(s) or an alloy of that with Si. The grown platelets (dendrites) of silicon are thus more pure than the starting silicon. The liquid alloy is preferably cooled at a slow rate, where the rate preferably lies between approximately 0.03-3° C. per minute, and more preferably lies between approximately 0.3-1° C. per minute. This can be achieved by either controlling the furnace cooling rate or casting the alloy in preheated and properly insulated moulds.

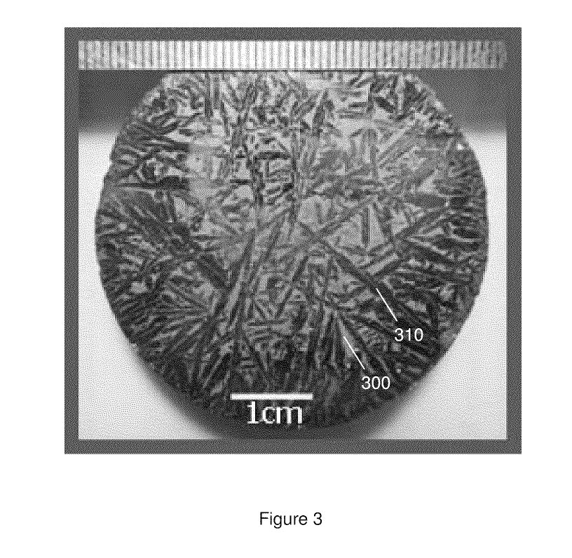

The alloy is solidified in step 120, preferably by quenching in water or casting in graphite mould, to facilitate subsequent comminution and to minimize diffusion of impurities back to the silicon dendrites. The alloy may be solidified from a temperature above the eutectic, when the getter phase is liquid, or below the eutectic, although the former is preferred. An exemplary image of the structure of the alloy after solidification is shown in FIG. 3. In this image, the light matrix 300 is an alloy of silicon-getter and the dark needles 310 are the platelets of purified silicon.

In order to facilitate the separation of the platelets of silicon from the matrix, a comminution step 130 is employed. Preferably, the solidified alloy is first crushed and ground, to liberate the silicon grains. This may be achieved by crushing the material down to an initial average particle size of about 0.5 cm, and subsequently grinding the particles in a ball mill to a final particle size for the liberation of silicon grains. The comminution steps may involve on or more of crushing, milling, ball-milling and grinding. The resulting particles will include matrix particles (i.e. particles comprising an alloy of silicon and getter metal) and particles comprising purified silicon (i.e. particles that mostly contain liberated silicon grains, but may further comprise some residual getter metal). The appropriate final particle size is dependent on the cooling rate and the alloy composition. Preferably, the particle size is less than one millimeter, and more preferably, between approximately 40 and 1200 microns. As is known in the art, filtering of particles based on size may be achieved by the mill itself having an installed screen on one end (or a cyclone may be used) so that the particles that are within the appropriate range are collected.

Finally, in step 140, a separation step is employed to separate the substantially purified silicon particles from the matrix particles. This is preferably achieved by selecting a getter metal that exhibits a physical or chemical property that is different from that of silicon and thus may be employed to separate purified silicon.

The separation of the liberated silicon grains from the matrix particles is preferably achieved by using difference in density or magnetic susceptibility of the two phases. As seen in Table 1 below, both properties are different for silicon and the preferred getter metals and alloys.

TABLE 1
Density and magnetic susceptibility of getter materials and silicon.

| | | Magnetic |
|---|---|---|
| | | Susceptibility × 10⁶ |
| Metal | Density, g/cm3 | (cm³/g) |
| Fe | 7.9 | Ferromagnetic |
| Cu | 9.0 | −5.46 |
| Zn | 7.1 | −11.4 |
| Ni | 8.9 | Ferromagnetic |
| Si | 2.3 | −3.9 |
| M—Al | 2.7 (for Al) | +16.5 (for Al) |

Heavy media separation is a preferred method for separating according to differences in density. A heavy media liquid with specific gravity between that of solid silicon and the getter metal is used. Some examples are LST™ (SG=2.85), tetrabromoethane (SG=2.96) and sodium polytungstate (SG=2.9). The product of milling is discharged and mixed well into the liquid. By providing sufficient time, that is dependent on the particle size and preferably 1 to 4 hours, light particles (silicon) are floated and the heavy particles (Si-getter metal/alloy) are sunk to the bottom. The phases are then separated and cleaned from the heavy media liquid by rinsing with water. The heavy media liquid is recycled. The floating particles comprise substantially purified silicon and may be used for further processing such as leaching and/or post-refining, discussed below. The settled fraction is a silicon-getter alloy that may be used as a desired feedstock for alloying and refining in other metallurgical processes or recycling.

In an alternative embodiment, a flowing liquid can be used as the separation medium. The powdered material is fed to an upward flowing stream (preferably water) with controlled flow rate. The light particles cannot sink and will overflow whereas the heavy particles are settled. Alternatively, a machine such as cyclone or mechanical classifier may be employed to separate heavy and light particles. Filtration of the particles is employed after the process to separate the particles from liquid. This step is preferably performed after milling and appropriate size separation (screening) to produce a ground product that has a substantially narrow particle size distribution.

In another embodiment, magnetic separation is employed to separate the purified silicon from the matrix. The getter metal or alloy is selected to have a sufficiently different magnetic susceptibility from silicon to enable magnetic separation. Suitable getter materials are shown in Table 1 above, and preferred metals include nickel and iron. Low or high intensity magnetic separators are preferably used to separate the substantially non-magnetic silicon particles from the ferromagnetic or paramagnetic alloy particles. This approach is most suitable when the getter element is ferromagnetic and its concentration is high (for Ni and Fe as getter).

Alternatively, leaching can be used as a separation or purification (cleaning) step. This is to dissolve the getter phase preferentially in a solution, while silicon remains unaffected by the solution. The getter phase surrounding the dendrites can be dissolved away and pure dendrites are extracted. Although this approach is applicable to any condition, it is preferably used if the fraction of silicon in the solidified product is large so that the interlocking of the dendrites would reduce the efficiency of separating the dendrites and the alloy using the aforementioned separation methods using gravity or magnetic susceptibility. Any suitable leachant such as HNO3, HCl, HF of appropriate concentration may be employed for this purpose.

If gravity or magnetic separation are used, an additional leaching step may be employed to further purify the extracted silicon particles. Although the dendrites are highly pure in silicon, they contain a small amount of the silicon-getter alloy that is physically stuck to the particles. By leaching this product, the majority of the impurities, in the form of adherent phase are removed. Any suitable leachant such as HNO3, HCl, HF or their mixtures with various concentrations can be employed for this purpose.

It has been observed that the majority of the impurities in the silicon leach residue are in the form of inclusions that are within the silicon grains and cannot be leached out. To further remove these inclusions, the silicon dendrites may be re-ground and leached again, in acid. The remaining silicon is filtered out and washed with water.

If may be desirable to perform an additional purification step to further purify the particles. The particles may be re-melted and cast into small diameter rods. Zone melting technique may be employed to remove trace amounts of impurities left in the silicon. Alternatively, the aforementioned separation methods according to various embodiments may be employed one or more additional times to further purify the silicon.

The initial source of silicon used in the aforementioned methods may have a wide range of purity levels. Preferably, the source is metallurgical grade silicon, preferably with a purity level of about 96% silicon or higher. The getter metal or alloy is preferably commercial grade, preferably with a purity of 99% or more, and more preferably with a purity greater than 99.99%. In addition, the getter metal may be alloyed with aluminum, titanium, calcium or other elements to improve the “gettering” effect and/or to reducing the melting point of the alloy.

The composition of the alloy can vary, as long as during solidification and above the eutectic point, silicon dendrites are formed. Ideally, the volume fraction of the primary silicon dendrites in the alloy just below the eutectic point is approximately 50 vol %. Preferred composition ranges and melting temperatures are provided in Table 2 below.

TABLE 2
Preferred concentration range and alloying temperature range of
silicon alloy.

| | | Melting Temperature |
|---|---|---|
| Alloy | Wt % Si (MGS) | (° C.) |
| Si—Fe | 62-90 | 1350-1400 |
| Si—Cu | 25-68 | 900-1300 |
| Si—Zn | 10-60 | 600-1050 |
| Si—Ni | 55-85 | 1100-1350 |
| Si—M—Al | Variable depending on M | Variable depending on M |
| (M: Cu, Ni, Cu, Fe) | | (from ternary diagram) |

With regard to the composition of the ternary alloys of Si-M-Al (M being any of Cu, Ni, Fe, Zn), and for the purpose of using density difference for separation, the ratio of M/Al can be varied as long as the density of the M-Al alloy is sufficiently large (preferably above around 3.0 g/cm³). If using magnetic susceptibility as the basis of separation, any alloy of Si-M-Al may be used as long as the volume percent of primary Si dendrites in the solidified alloys is at an appropriate range for separation (preferably 20-80 vol %). However, for this latter application the performance of Fe—Al and Ni—Al alloys with a ratio of M/AI greater than unity are superior due to the ferromagnetic properties of Fe and Ni. The leaching process can be applied to any alloy of Si—Al-M to dissolve away the alloy surrounding Si dendrites.

Depending on the initial boron and phosphorus contents of silicon and the getter metal, there may be a benefit in adding some titanium and/or calcium to the alloy, to act as a refiner. Titanium has an affinity for boron and may be employed for its removal. Similarly, calcium may be employed for the removal of phosphorus. Preferably, the amount of titanium and calcium employed are below 5% and at least 2 times by weight of the total amount of boron and phosphorus existing in the alloy.

The alloy is preferably contained in magnesia, alumina, mulite, graphite, or quartz crucibles and protected against oxidation by melting under vacuum or inert (such as argon) atmosphere. Inert gas agitation is preferably used for faster homogenization of the liquid. The melt is preferably covered with a silicate base slag (such as CaO—SiO2 or CaF2—SiO2) to both protect silicon against oxidation and may also be used to remove impurities such as phosphorous.

The following examples are presented to enable those skilled in the art to understand and to practice the present invention. They should not be considered as a limitation on the scope of the invention, but merely as being illustrative and representative thereof.

### EXAMPLES

### Example 1

### Copper as Getter Metal

Four hundred grams of Metallurgical Grade Silicon (˜3300 ppm total impurity, with Al and Fe being major impurities) and copper (˜1800 ppm impurity, majority being Fe) were used to make an alloy containing 50 wt % of each. The batch was melted and homogenized at 1450° C. in an alumina crucible for half an hour under argon atmosphere. It was then cooled to room temperature at the rate of 0.5° C./min, to allow formation of the Si dendrites. The solidified alloy was ground to fine particles using an alumina mortar and pestle. Particles ranging from 53 to 212 pm were screened out using a set of sieves staked up in a rotating/tapping machine.

The Si-rich particles were separated from the rest of the alloy using a heavy media of density 2.85 g/cm³. The separation was deemed complete when every visible particle reported to either the floats light fraction) or sinks (heavy fraction). The light fraction, being Si, was recovered for further processing by collecting the floats and passing them through a filter paper, while washing with water.

After separation, the light fraction was further cleaned by washing with water. It was then leached in 10% HNO3 for 10 hours at room temperature to dissolve the adherent Cu—Si alloy remaining at the surface of the particles. The product was then filtered and washed with de-ionized water. The produced Si was analyzed, the results of which are provided in the following table. As seen, the concentration of impurities has decreased by a factor of 30, by one-time upgrading.

TABLE 3
Concentrations of impurities in metallurgical silicon,
silicon alloy, and purified silicon (ppm).

| Impurity | MG-Si | Cu—Si | Si |
|---|---|---|---|
| B | 18 | 38 | 19 |
| P | 16 | 13 | 18 |
| Al | 335 | 150 | 2.4 |
| Ca | 5.6 | 1.5 | 1.9 |
| Ti | 35 | 75 | 1 |
| V | 1.7 | 12 | 0.62 |
| Cr | 8.7 | 20 | 2.2 |
| Mn | 55 | 260 | 0.56 |
| Fe | 2800 | 1200 | 15 |
| Co | 1.3 | 2.6 | 0.1 |
| Ni | 7.1 | 23 | 0.46 |
| Cu | 24 | Major | 45 |
| Total Impurity | 3307 | 1795 | 106 |

### Example 2

### Determination of Preferred Cooling Rate and Particle Size

In a different set of experiments, to determine the optimum cooling rate and particle size for phase separation, several alloys ranging from 30 to 70 wt % Si were made. They were then cooled at rates between 0.5-3.0° C./min. The products were then ground and split into batches with various particle size distributions. The product Si was then analyzed. It was found that under all conditions, the product Si has a higher purity than the starting Metallurgical Grade Silicon. However, the highest extent of purification was obtained with a cooling rate of 0.5° C./min and a particle size ranging from 53 to 212 μm.

Lower percentage of Si in the starting mix of the alloy would result in higher purity of the product. However, this is achieved at the cost of lower productivity and silicon yield, as well as higher energy consumption.

### Example 3

### Ni as Getter Metal

118 grams of Metallurgical Grade Silicon powder with purity of 98.5% was mixed with 62 grams of Ni powder. Three similar mixtures were made, 180 grams each. Each batch was loaded into a mullite crucible and melted in a muffle furnace under flowing high purity argon at 1600° C. The melt was held for 4 hours after which it was cooled to 920° C. at a specific cooling rate, 0.5, 1.5, and 3.0° C./min. Once the sample temperature reached 920° C., the crucible was quenched in water. The alloy was taken out from the crucible, crushed to a particle size smaller than 1190 μm. Two grams of each powder was loaded into a beaker containing LST heavy media with a specific gravity of 2.85. The Si rich particles were floated and recovered. The recovery of Si particles ranged from 60 to 95 wt % and the percent of Si in the floats was in the range of 75-94%.

The alloy phase adherent to the Si particles was dissolved in 40 mL of HF solution [HF: H2O, 1:3] inside a Teflon beaker that was placed in an aqueous bath at 60° C. After 4 hours, the remaining Si solids were filtered, rinsed thoroughly in de-ionized water and analyzed. For the samples showing lowest impurity content, the percent removal of each impurity impurities compared to the original metallurgical grade silicon was as follows (concentrations in parenthesis are in ppmwt): Al: 99.5% (from 1488 to 8), As: 76.7% (from 8 to 1.86), Ba: 72.3% (from 12 to 3.32), Ca: 97.8% (from 630 to 1.37), Cd: 60% (from 10 to 4), Cr: 80.2% (from 8 to 1.59), Fe: 99.6% (from 2792 to 10.26), K: 99.7% (from 44 to 0.13), Mg: 96.9% (from 118 to 3.65), Mn: 99.4% (from 158 to 1), Mo: 97.8% (from 6 to 0.13), V: 98.8% (from 86 to 1), Zn: 87.5% (from 16 to 2).

### Example 4

### Ca as Getter Metal

27 Grams of metallurgical grade silicon powder was mixed with 3 grams of calcium powder. The mixture was heated to and held at 1600° C. for 3 hours under argon atmosphere. The melts was then cooled to 924° C. at a rate of 0.5° C./min. Once the sample temperature reached 924° C., the crucible was quenched in water. On solidification, the samples contained two separate phases of CaSi2 and Si according to EPMA analysis. The analysis of the two phases below showed that the impurities preferentially migrated to the CaSi2 phase, thus producing a silicon much more pure that the starting material. The ratio of the impurities in these phases (and the concentrations in ppmwt in parenthesis) is as follows: Mg: 4.0 (35:9), K: 2.0 (23:11), Ni: 1.9 (124:65), V: 1.2 (41:30), Mn: 1.4 (54:38), P: 3.6 (80:22), Fe: 15.1 (520:34), Al: 330.4 (4418:13), Cu: 5.5 (190:35), Zn: 3.7 (111:65).

### Example 5

### Fe as Getter Metal, Slow Cooling to Below Eutectic Temperature

Three samples, each 200 grams, of 72% Fe-28% Si alloy were made by mixing powders of metallurgical grade silicon and iron. The mixture was melted under argon at 1600° C. for 3 hours. Each batch was cooled to 1100° C. at a specific cooling rate, 0.5, 1.5, and 3.0° C./min. Once the sample temperature reached 1100° C., the crucible was quenched in water. The alloy was then crushed to particles all passing 1190 μm sieve. 15 Grams of each powder was loaded into a beaker containing LST heavy media with specific gravity of 2.85. The Si rich particles were floated and recovered. The recovery of Si particles ranged from 77-94 wt % and the percent of Si in the floats was in the range of 80-96%.

Two grams of each batch was leached in 20 ml of HF solution [HF: H2O, 1:3]. The solution was held at 75° C. and stirred for 4 hours. After 4 hours, the remaining solids being Si were filtered, rinsed thoroughly in de-ionized water and analyzed. The percent removal of the impurities compared to the original metallurgical grade silicon were as follows: Al: 94.7% (from 980 to 51.7), Ba: 97.1% (from 12 to <0.4), Cd: 66.8% (from 38 to 12.6), Cr: 68% (from 5 to 1.6), K: 93.2% (from 39 to 2.7), Mg: 96.0% (from 57 to 2.3), Mn: 96.3% (from 158 to 5.8), V: 75.9% (from 86 to 20.7), Zn: 90.5% (from 23 to 2.2), Ni: 96.6% (from 118 to 4), Li: 93.3% (from 3 to <0.2). Be: 36.3% (from 1 to 0.6).

### Example 6

### Fe as Getter Metal, Quenching from Above Eutectic

10.8 Grams of metallurgical grade silicon powder with purity of 98.5% was mixed with 4.2 grams of electrolytic Fe powder with 99.998% purity. The mixture was loaded into an alumina crucible and melted in a horizontal tube furnace under flowing high purity argon at 1600° C. The melt was held for 4 hours after which it was cooled to 100° C. above eutectic temperature (1220° C.) at the cooling rate of 0.5° C./min. Once the sample temperature reached 1220° C., the crucible was quenched in water. The alloy was ground to particles smaller than 212 μm. Two grams of the powder was treated for 4 hours in 20 ml of HF solution [HF: H2O, 1:3] held at 75° C. The residue was analyzed as the purified Si. For the samples showing lowest impurity content, the percent removal of the impurities compared to the original metallurgical grade silicon were: Al: 99.0% (from 980 to 10), Ba: 90.0% (from 12 to <0.1), Cd: 5.3% (from 38 to 36), Cr: 80% (from 5 to 1), Fe: 57.4% (from 3108 to 404), K: 97.4% (from 39 to 1), Mg: 99.8% (from 57 to <0.1), Mn: 97.5% (from 158 to 4), V: 99.4% (from 86 to <0.3), Zn: 98.3% (from 23 to <0.4), Ni: 51.7% (from 118 to 57), Li: 93.3% (from 3 to <0.2), P: 57.4 (from 68 to 29), B: 55.6% (from 27 to 12), Be: 90.0% (from 1 to 0.1).

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

### REFERENCES

[1] M. Shmelta, Photon International, March 2004
[2] A. Muller, M. Ghosha, R. Sonnenschein, P. Woditsch, Materials Science and Engineering B 134 (2006) 257-262
[3] L. N. Berg, InforPoint Renewable Energy, April 2004, pp. 4-5
[4] Handbook of Photovoltaic Science and Engineering, Edited by A. Luque and S. Hegedus John Wiley & Sons Ltd., 2003
[5]. Lynch, D., Journal of Metals, 2009. 61(11): p. 41-48.
[6] J. L. Gumaste, B. C Mohanty, R. K Galgali, U. Syamaprasad: Solar Cell Materials, 16 (1987), 289
[7] P. S. Kovtal, H. B. Strock, Process for the Production of Refined Metallurgical Grade Silicon, U.S. Pat. No. 4,195,067, 1980.
[8] Takashi Yoshikawa and Kazuki Morita: Science and Technology Advanced Materials, 4 (2003), 531
[9] Takashi Yoshikawa and Kazuki Morita: Metallurgical and Materials Transactions B, 36B (2005), 731
[10] Takashi Yoshikawa and Kazuki Morita: Journal of Crystal Growth, (2008)
[11] Takashi Yoshikawa and Kazuki Morita: TMS, EDP Congress 2005
[12] J. Park, K. Sassa and S. Asai: J. Jpn. Inst. Met., 59 (1995), 733
[13] Takashi Yoshikawa and Kazuki Morita: ISIJ International, 45 (2005), 967
[14] Takashi Yoshikawa and Kazuki Morita: ISIJ International, 47 (2007), 582
[15] J. S. Kang and D. K. Schroder: J. Appl. Phys. 65 (8), 1989
[16] M. L. Polignano et. Al: J. Appl. Phys. 64 (2), 1988

1. A method for reducing a concentration of an impurity in impure silicon, comprising the steps of:
forming a liquid alloy comprising said impure silicon and a getter metal;
cooling said liquid alloy to obtain silicon platelets within said liquid alloy;
solidifying said liquid alloy to form a solid comprising said silicon platelets and a silicon-getter alloy;
processing said solid to obtain particles of sufficiently small size that a fraction of said particles are substantially silicon particles formed from said platelets; and
separating said substantially silicon particles;
wherein a solubility of said impurity is greater in said getter metal than in said silicon platelets.

2. The method according to claim 1 wherein said getter metal comprises one of a metal and an alloy.

3. The method according to claim 1 wherein a solubility of said getter metal in silicon is less than approximately 1 ppm by weight.

4. The method according to claim 1 wherein a phase diagram of silicon and said getter metal comprises a concentration range of said getter metal wherein said silicon platelets may form within said liquid alloy, and wherein a concentration of said getter metal is chosen to lie within said concentration range.

5. The method according to claim 1 wherein said impure silicon is metallurgical grade silicon.

6. The method according to claim 1 wherein said getter metal is selected from the group consisting of copper, nickel, tin, iron, and zinc.

7. The method according to claim 6 wherein said getter metal further comprises an alloy comprising said metal and aluminum.

8. The method according to claim 1 further comprising the step of adding a quantity of titanium to said liquid alloy to reduce a concentration of boron in said substantially silicon particles.

9. The method according to claim 1 further comprising the step of adding a quantity of calcium to said liquid alloy to reduce a concentration of phosphorus in said substantially silicon particles.

10. The method according to claim 1 wherein said impure silicon has a silicon concentration of greater than approximately 96%.

11. The method according to claim 1 wherein said getter metal has a purity of greater than about 99%.

12. The method according to claim 1 The method according to any one of claims 1 to 11 wherein said cooling is performed at a rate of approximately 0.03 to 3° C. per minute.

13. The method according to claim 1 wherein said step of processing said solid is selected from the group consisting of crushing, milling, ball-milling and grinding.

14. The method according to claim 13 wherein particles obtained after said processing step are filtered by particle size to obtain particles with an average size in the range of approximately 40-1200 microns.

15. The method according to claim 1 wherein said particles are separated by gravity separation wherein a specific gravity of said getter metal is substantially different from the specific gravity of silicon.

16. The method according to claim 15 wherein said particles obtained after said processing step are added to a liquid having a specific gravity between that of said getter metal and that of silicon.

17. The method according to claim 15 wherein prior to said step of separating said particles, a substantially uniform particle size distribution is obtained, and wherein lighter particles are subsequently separated from heavier particles by feeding said particles with a substantially uniform size distribution to one of an upward flowing stream, a cyclone, and a mechanical classifier.

18. The method according to claim 15 wherein particles obtained after said separation step are chemically leached to further improve a purity of said substantially silicon particles.

19. The method according to claim 1 wherein said particles are separated by magnetic separation wherein the magnetic susceptibility of said getter metal is substantially different from the magnetic susceptibility of silicon.

20. The method according to claim 19 wherein said getter metal is ferromagnetic.

21. The method according to claim 19 wherein one of low and high intensity magnetic separators are used to perform said separation.

22. The method according to claim 1 wherein particles obtained after said separation step are chemically leached to further improve a purity of said substantially silicon particles.

23. A method for reducing a concentration of an impurity in impure silicon, comprising the steps of:
forming a liquid alloy comprising said impure silicon and a getter metal,
cooling said liquid alloy to obtain silicon platelets within said liquid alloy;
solidifying said liquid alloy to form a solid comprising said silicon platelets and a silicon-getter alloy; and
separating said silicon platelets from said silicon-getter alloy by chemical leaching,
wherein a solubility of said impurity is greater in said getter metal than in silicon, and a solubility of said getter metal in silicon is selected to limit the formation of impurities in said platelets by said getter metal.

24. The method according to claim 23 wherein said getter metal comprises one of a metal and an alloy.

25. The method according to claim 23 wherein a solubility of said getter metal in silicon is less than approximately 1 ppm by weight.

26. The method according to claim 23 wherein a phase diagram of silicon and said getter metal comprises a concentration range of said getter metal wherein said silicon platelets may form within said liquid alloy, and wherein a concentration of said getter metal is chosen to lie within said concentration range.

27. The method according to claim 23 wherein said impure silicon is metallurgical grade silicon.

28. The method according to claim 23 wherein said getter metal is selected from the list consisting of copper, nickel, tin, iron, and zinc.

29. The method according to claim 28 wherein said getter metal further comprises an alloy comprising said metal and aluminum.

30. The method according to claim 23 wherein said chemical leaching is achieved with a leachant selected from the list comprising HNO3, HCl, and HF.
